(19) United States
(12) Patent Application Publication
(10) Pub. No.: US 2013/0153687 A1
(43) Pub. Date: Jun. 20, 2013

(54) MISTING NOZZLE

(71) Applicant: Pai-Chou Hsieh, Chang-Hua County (TW)

(72) Inventor: Pai-Chou Hsieh, Chang-Hua County (TW)

(73) Assignee: YUAN PIN INDUSTRIAL CO., LTD., CHANG-HUA COUNTY (TW)

(21) Appl. No.: 13/332,255

(22) Filed: Dec. 20, 2011

(51) Int. Cl. B05B 1/00

(52) U.S. Cl. 239/589

(57) ABSTRACT

A misting nozzle includes a body having a through hole longitudinally and centrally defined therein. A cap is longitudinally and airtightly mounted to the mounting section of the body. The cap includes a cavity centrally and longitudinally defined therein and a funnel-shaped hole centrally defined in the bottom of the cavity. A guide element is airtightly received in the smooth portion of the cavity. The guide element includes multiple ditches equally longitudinally defined in the outer periphery of the guide element. A round recess is centrally defined in the abutment and communicating with the funnel-shaped hole. Multiple grooves are respectively defined in the abutment. Each groove is defined along a corresponding one of the tangents of the recess and having two opposite ends respectively communicating with the recess and a corresponding one of the ditches.

### BACKGROUND OF THE INVENTION

1. Field of the Invention

The present invention relates to a misting nozzle, and more particularly to a misting nozzle that can effectively mist water.

2. Description of Related Art

A conventional misting nozzle in accordance with the prior art shown in FIGS. 6-8 comprises a body (10) having a through hole (12) centrally defined therein and a cavity (11) in one end thereof and communicating with the through hole (12). A rotor (20) is rotatably and movably received in the through hole (12). The rotor (20) has an inclined face formed on a first thereof and at least two inclined guide grooves (21) defined in a second end of the rotor (20), wherein the two guide grooves (21) correspond to the cavity (11). A cap (30) is tightly inserted into the cavity (11) to prevent the rotor (20) from detaching from the body (10). The cap (30) has a recess (33) centrally defined therein for rotatably receiving the second end of the rotor (20) when being operated. A tapered hole (32) is centrally defined in a bottom of the recess (33) and a spray hole (31) is centrally defined in the cap (30) and communicates with the tapered hole (32).

When misting water, the rotor (20) is rotated in a high speed when high-pressure water flows into the body (10) and passed through the inclined face (22). As a result, the high-pressure water is misted and sprayed from the spray hole (31) after passing through the two guide grooves (21).

However, the rotor (20) is moved in the through hole (12) due to a pressure of the water that flows through the body (10) such that the gap between the top of the rotor (20) and the cap (30) is changeable. As a result, the water may not be misted when the pressure has been lowed and the gap between the top of the rotor (20) and the cap (30) has been enlarged.

The present invention has arisen to mitigate and/or obviate the disadvantages of the conventional misting nozzle.

### SUMMARY OF THE INVENTION

The main objective of the present invention is to provide an improved misting nozzle that can effectively mist water when the water pressure is low.

To achieve the objective, the misting nozzle in accordance with the present invention comprises a body having a through hole longitudinally and centrally defined therein. A flange radially extends from the body to divide the body into a connecting section and a mounting section, wherein the connecting section is adapted to be inserted into a hose/pipe. A cap is longitudinally and airtightly mounted to the mounting section of the body. The cap includes a cavity centrally and longitudinally defined therein. The cavity has a smooth portion formed near a bottom thereof. The cap includes a funnel-shaped hole centrally defined in the bottom of the cavity. A guide element is airtightly received in the smooth portion of the cavity, wherein the guide element has a thickness smaller than a depth of the smooth portion. The guide element includes an abutment airtightly abutting against the bottom of the cavity and an outer periphery airtightly abutting against an inner periphery of the smooth portion of the cavity. The guide element includes multiple ditches equally longitudinally defined in the outer periphery of the guide element. A round recess is centrally defined in the abutment and communicating with the funnel-shaped hole. Multiple grooves are respectively defined in the abutment. Each groove is defined along a corresponding one of the tangents of the recess and having two opposite ends respectively communicating with the recess and a corresponding one of the ditches, wherein each groove has a width and a depth respectively smaller than that of the corresponding ditch for raising the water pressure when passing therethrough.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a misting nozzle in accordance with the present invention;

FIG. 2 is an exploded perspective view of the misting nozzle in FIG. 1;

FIG. 3 is another exploded perspective view of the misting nozzle in FIG. 1;

FIG. 4 is a perspective operational view of the misting nozzle in accordance with the present invention;

FIG. 5 is a cross-sectional operational view of the misting nozzle in accordance with the present invention;

FIG. 6 is an exploded perspective view of a conventional misting nozzle in accordance with the prior art;

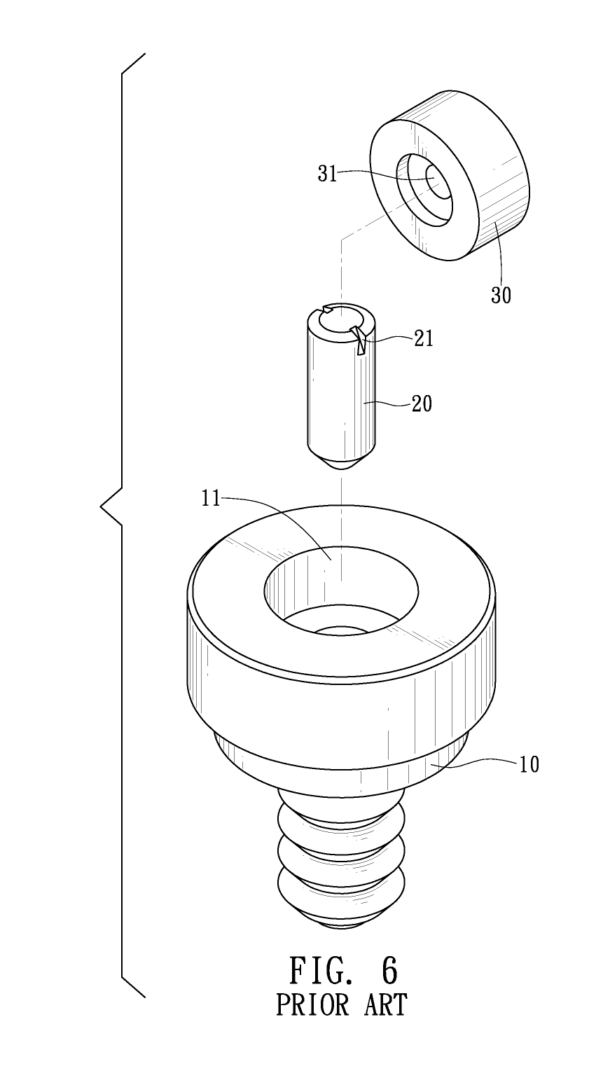

FIG. 7 is a partially cross-sectional view of the conventional misting nozzle in accordance with the prior art;

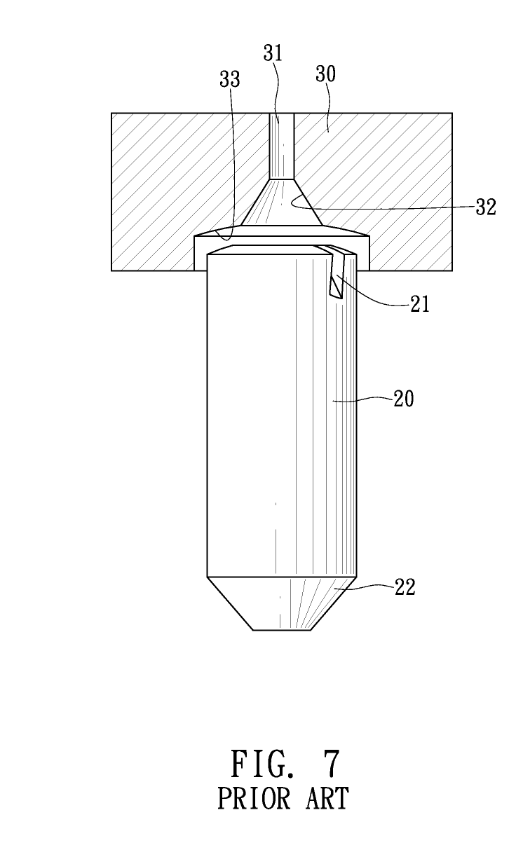

FIG. 8 is a cross-sectional view of the conventional misting nozzle in accordance with the prior art; and

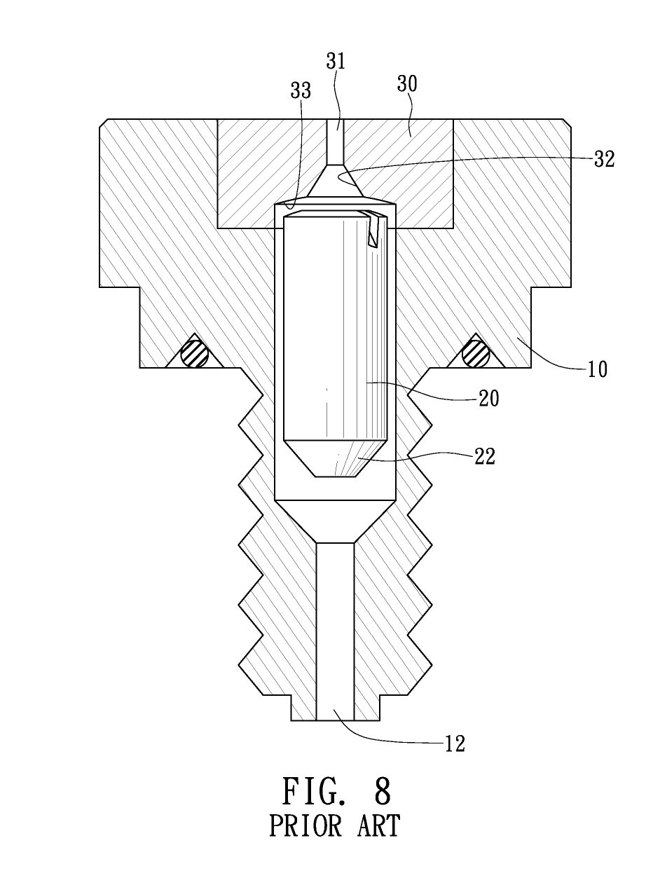

FIG. 9 is an operational view in cross-section of the conventional misting nozzle in accordance with the prior art.

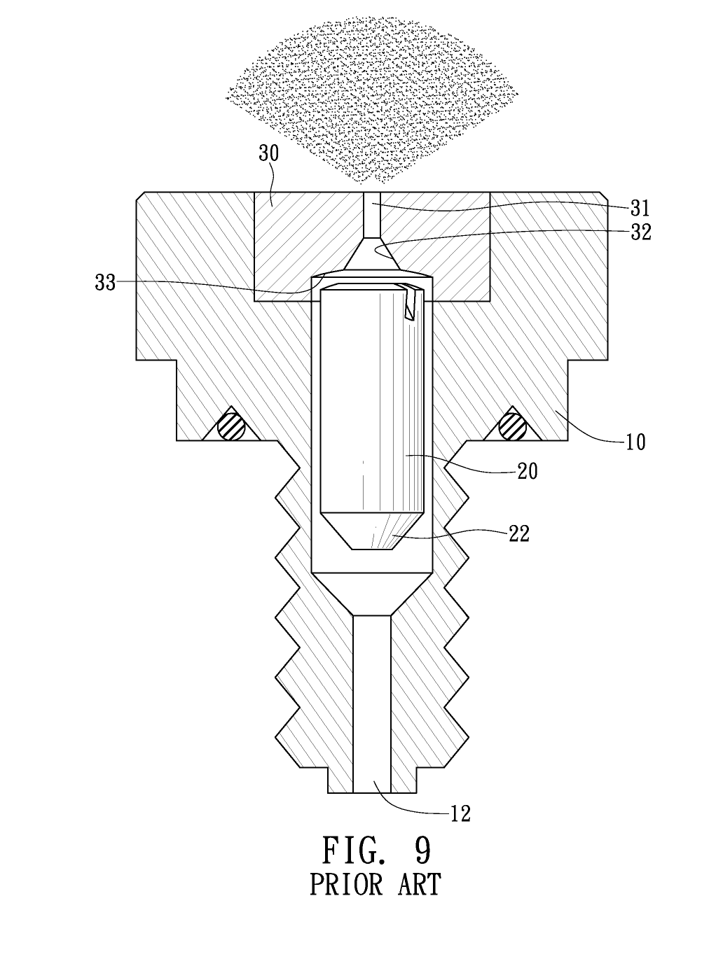

### DETAILED DESCRIPTION OF THE INVENTION

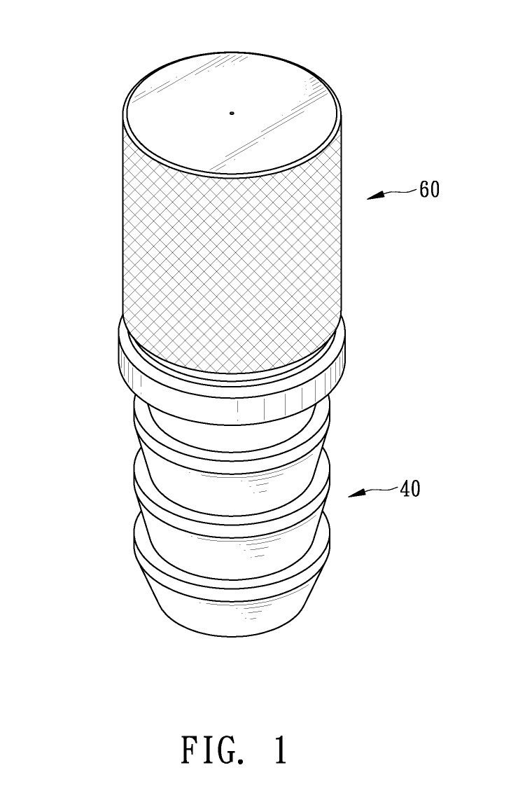

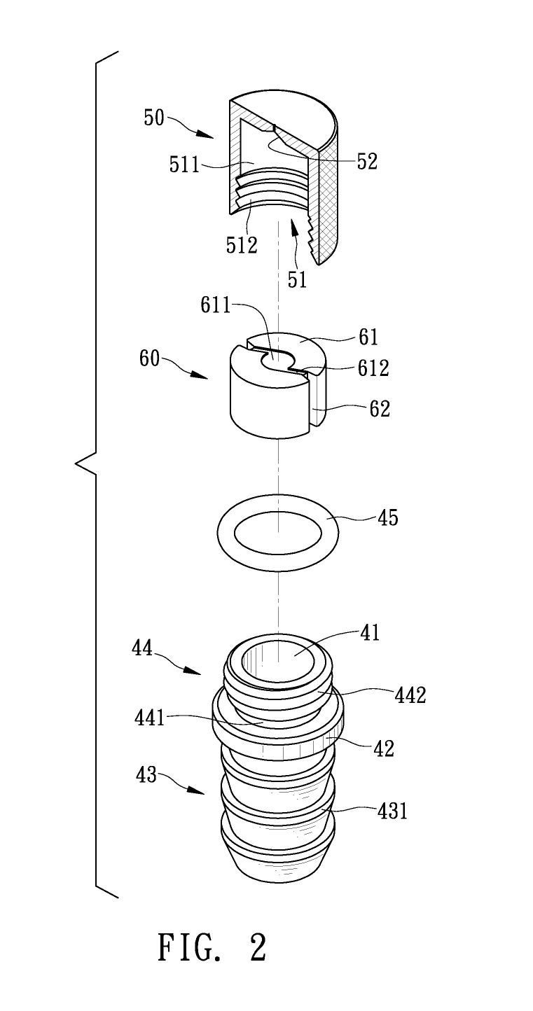

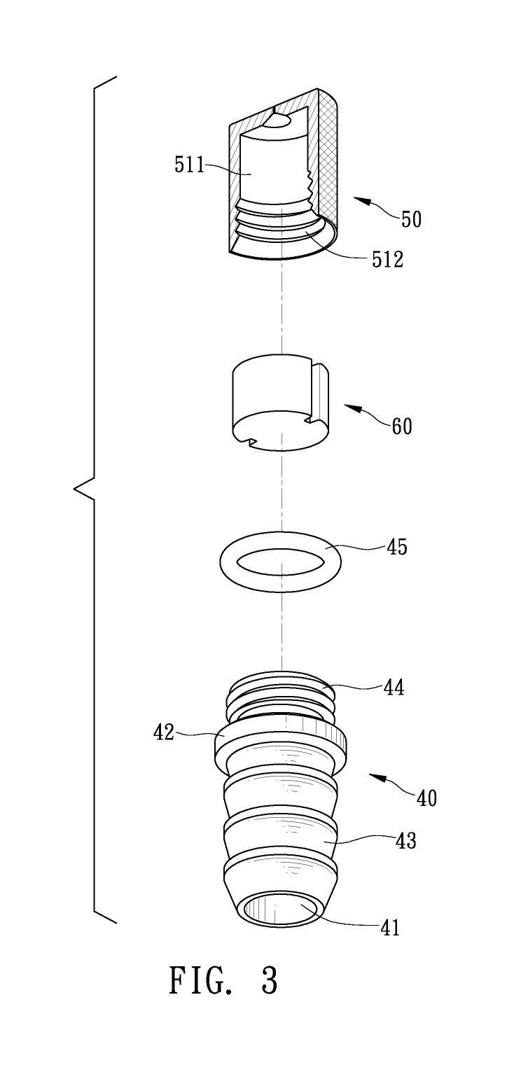

Referring to the drawings and initially to FIGS. 1-3, a misting nozzle in accordance with the present invention comprises a body (40), a cap (50) longitudinally and airtightly mounted onto the body (40) and a guide element (60) airtightly receiving in the cap (50), wherein the guide element (60) longitudinally abuts against a bottom of the cap (50).

The body (40) has a through hole (41) longitudinally and centrally defined therein. The body (40) includes an annular flange (42) radially extending therefrom to divide the body (40) into a connecting section (43) and a mounting section (44). The connecting section (43) is provides to be inserted into a hose or a pipe (not shown). In the preferred embodiment of the present invention, the connection section (43) is inserted to the hose and has a series of annular ratchet structures (431) for promoting a friction force between the connecting section (43) and an inner periphery of the hose. The mounting section (44) includes an annular groove (441) defined therein near the annular flange (43) and a threaded portion (442) formed thereon. An O-ring (45) is received in the annular groove (441).

The cap (50) has a cavity (51) centrally and longitudinally defined therein. The cavity (51) is divided into a smooth portion (511) and a threaded portion (512), wherein the threaded portion (512) is screwed onto the threaded portion (442) of the body (40) to make the distal edge of the cap (50) airtightly abutting the O-ring (45), and the smooth portion (511) has a diameter smaller than that of threaded portion (512) of the cap (50). A funnel-shaped hole (52) is defined in a bottom of the cavity (51).

The guide element (60) is airtightly received in the smooth portion (511), wherein the guide element (60) has a thickness smaller than a depth of the smooth portion (511). The guide element (60) includes an abutment (61) airtightly abutting against the bottom of the cavity (51) and an outer periphery airtightly abutting against an inner periphery of the smooth portion (511) of the cavity (51). The guide element (60) includes multiple ditches (62) equally longitudinally defined in the outer periphery of the guide element. A round recess (611) is centrally defined in the abutment (61) and communicates with the funnel-shaped hole (52). Multiple grooves (612) respectively defined in the abutment (61). Each groove (612) is defined along a corresponding one of the tangents of the recess (611) and has two opposite ends respectively communicating with the recess (611) and a corresponding one of the ditches (62). Each groove (612) has a width and a depth respectively smaller than that of the corresponding ditch (62) for raising the water pressure when passing therethrough.

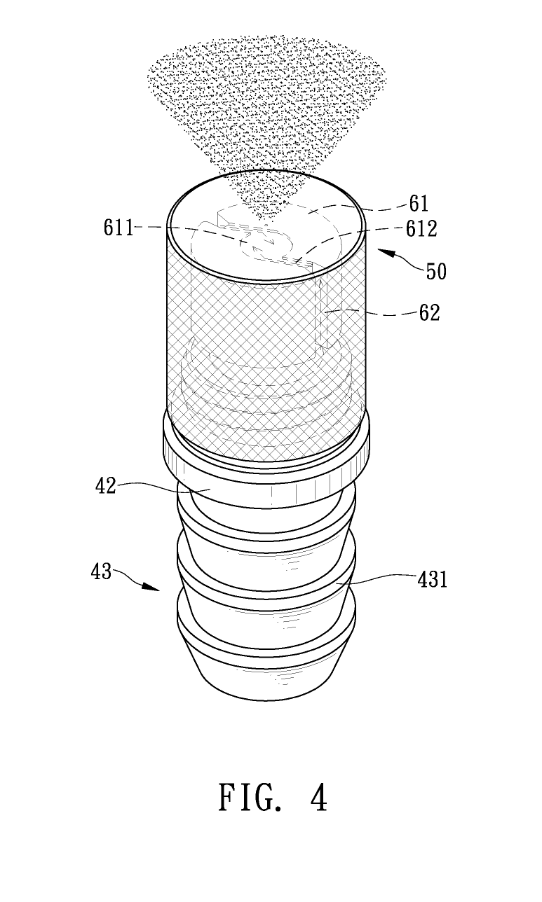

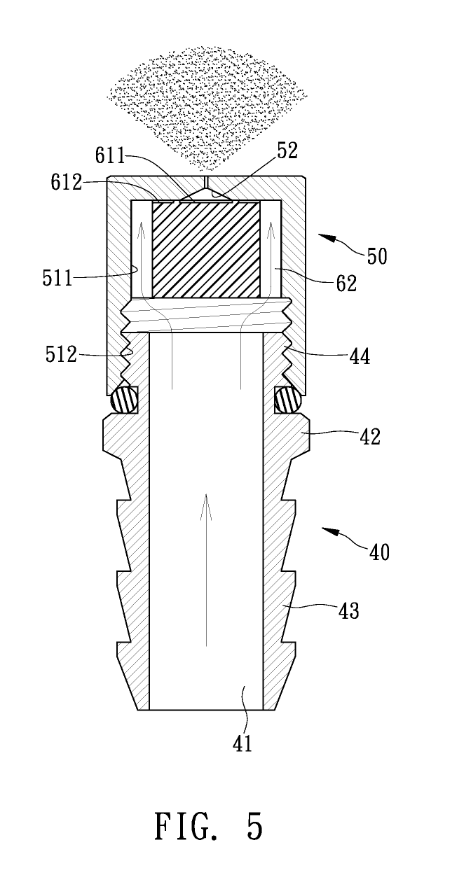

With reference to FIGS. 4 and 5, when misting the water from the hose or pipe, the water sequentially flows through the through hole (41), the two ditches (62) and the two grooves (612) into the recess (611), and forms a speedy eddy in the recess (611) for completely misting the water before spraying from the funnel-shaped hole (52) because each groove (612) is defined along a tangent of the recess (611). As a result, the water, flowing in the misting nozzle in accordance with the present invention, does need a high pressure and can be completely misted in the recess (611) due to the multiple grooves (612) because they are defined along tangents of the recess (611).

Although the invention has been explained in relation to its preferred embodiment, it is to be understood that many other possible modifications and variations can be made without departing from the spirit and scope of the invention as hereinafter claimed.

What is claimed is:

1. A misting nozzle comprising:
a body having a through hole longitudinally and centrally defined therein, a flange radially extending from the body to divide the body into a connecting section and a mounting section, wherein the connecting section is adapted to be inserted into a hose;
a cap longitudinally and airtightly mounted to the mounting section of the body, the cap including a cavity centrally and longitudinally defined therein, the cavity having a smooth portion formed near a bottom thereof, the cap including a funnel-shaped hole centrally defined in the bottom of the cavity; and
a guide element airtightly received in the smooth portion of the cavity, wherein the guide element has a thickness smaller than a depth of the smooth portion, the guide element including an abutment airtightly abutting against the bottom of the cavity and an outer periphery airtightly abutting against an inner periphery of the smooth portion of the cavity, the guide element including multiple ditches equally longitudinally defined in the outer periphery of the guide element, a round recess centrally defined in the abutment and communicating with the funnel-shaped hole, multiple grooves respectively defined in the abutment, each groove defined along a corresponding one of the tangents of the recess and having two opposite ends respectively communicating with the recess and a corresponding one of the ditches, wherein each groove has a width and a depth respectively smaller than that of the corresponding ditch for raising the water pressure when passing therethrough.

2. The misting nozzle as claimed in claim 1, wherein the mounting section of the body includes an annular groove defined therein near the annular flange and an O-ring received in the annular groove.

3. The misting nozzle as claimed in claim 2, wherein the mounting section of the body has a threaded portion formed thereon and the cavity has a threaded portion formed on an inner periphery of the cavity, wherein the threaded portion of the cavity is screwed onto the threaded portion of the body to make a distal edge of the cap airtightly abutting against the O-ring.

4. The misting nozzle as claimed in claim 1, wherein the connecting section includes a series of annular ratchet structures for promoting a friction force between the connecting section and an inner periphery of the hose.

5. The misting nozzle as claimed in claim 2, wherein the connecting section includes a series of annular ratchet structures for promoting a friction force between the connecting section and an inner periphery of the hose.

6. The misting nozzle as claimed in claim 3, wherein the connecting section includes a series of annular ratchet structures for promoting a friction force between the connecting section and an inner periphery of the hose.
